(19) United States
(12) Patent Application Publication
(10) Pub. No.: US 2005/0208810 A1
(43) Pub. Date: Sep. 22, 2005

(54) Configuration for connecting energy transmission lines

(76) Inventors: Alois Wimmer, Hof bei Salzburg (AT); Erich Greisberger, Thalgau (AT)

Correspondence Address: LERNER AND GREENBERG, PA, P O BOX 2480, HOLLYWOOD, FL, 33022-2480, US

(21) Appl. No.: 11/101,108

(22) Filed: Apr. 7, 2005

(30) Foreign Application Priority Data
Feb. 23, 2004 (AT) AT GM 127/2004

(51) Int. Cl. H01R 4/60

(52) U.S. Cl. 439/191

(57) ABSTRACT

An arrangement for connecting energy lines, in particular pressure lines, such as, for example, hydraulic lines, of tools to be supplied with energy, in particular pressure-actuated tools to pressure supply lines, it being possible for the tools to be secured to the tool carrier in a fixed position in a locked manner, and at least one respective coupling part being provided on the tool and on the tool carrier, which coupling parts are located coaxially opposite one another in the mutually secured state, and of which coupling parts one coupling part engages in the opposite mating coupling part in the coupled state. In order to enable energy lines to be coupled independently of the coupling of the tool to the tool carrier, provision is made for one of the two coupling parts (6, 25), in particular the coupling part provided on the tool carrier (3), to have a coupling sleeve (25) which is tightly guided in a displaceable manner in the axial direction of the coupling part and can be pushed in a sealing manner into the opposite coupling part (6) or can be pushed onto the latter.

The invention relates to an arrangement for connecting energy lines, in particular pressure lines, such as, for example, hydraulic lines, of tools to be supplied with energy, in particular for connecting pressure-actuated tools to pressure supply lines, it being possible for the tools to be secured to the tool carrier in a fixed position, and at least one respective coupling part being provided on the tool and on the tool carrier, which coupling parts are located coaxially opposite one another in the mutually secured state, and of which coupling parts one coupling part engages in the opposite mating coupling part in the coupled state.

It is already known to secure tools to a tool carrier by means of automatically working coupling devices, a hook connection being provided which serves to initially connect the two parts and to orient the tool with regard to the tool carrier, and a positive-locking connection being provided which then locks the tool on the tool carrier in a fixed position. In these known designs, it is then often necessary to manually couple hydraulic lines which are necessary for actuating the tools, or also electrical lines if the tool is to be supplied with electrical energy, or coupling blocks are also already known, which, however, have the disadvantage that tool and tool carrier must already be aligned with one another so accurately that the corresponding coupling parts fit together exactly. However, this is possible only with difficulty, in particular in construction machines or the like in rough everyday operation, so that damage to the coupling parts of the lines often occurs. The two parts of the pressure lines or energy supply lines which are to be coupled to one another also often do not perform a rectilinear coaxial movement relative to one another, but rather perform a swinging movement, a factor which makes it additionally difficult to orient the individual parts relative to one another.

The object of the invention is to improve an arrangement of the type mentioned at the beginning in such a way that the abovementioned disadvantages are avoided.

According to the invention, this is achieved in that one of the two coupling parts, in particular the coupling part provided on the tool carrier, has a coupling sleeve which is tightly guided in a displaceable manner in the axial direction of the coupling part and can be pushed in a sealing manner into the opposite coupling part or can be pushed onto the latter. It is thus possible to attach the tools to the tool carrier and to lock them thereon independently of the coupling of the energy supply lines, since first of all the locking of the tools in a fixed position on the tool carrier can be carried out and only after that, when all the parts are already held in a fixed position, is the coupling of the energy supply lines effected.

The guide of the displaceably guided coupling sleeve may advantageously be formed as a hydraulic cylinder, a ring arranged on the outer lateral surface of the coupling sleeve being provided as piston. Such a design has the advantage that the inner passage through the coupling sleeve for the feeding of hydraulic fluids during the coupling of hydraulic lines remains free, it being possible, when used on electrical couplings, for the terminal which is to be coupled to be guided in an isolated manner relative to the tool carrier. In order to be sure that complete coupling of the energy lines is effected, the stroke of the hydraulic cylinder may be greater than the distance between the two opposite coupling parts. Clearance tolerances between the tools and the tool carrier can thus also be compensated for. Furthermore, at least one of the coupling parts may be mounted on its carrier in a floating manner but so as to be movable to a limited extent in the axial direction, thereby achieving the effect that the coupling sleeve can be oriented at the mating coupling part without being prevented from moving axially by positive guidance. To facilitate the insertion of the coupling sleeve into the mating coupling part, that end of the coupling sleeve which can be inserted may be designed to taper conically toward the free edge. In order to be able to automatically hold the coupling sleeve in its advanced, coupled position, a pilot-controlled check valve may be provided in the hydraulic circuit pressurizing the coupling sleeve, in particular in the line leading in on the rear side of the piston. Thus pressure applied to the rear side of the piston is automatically maintained without additional hydraulic fluid in the entire system having to be kept under pressure. To release the coupling, the check valve can be opened, whereby the return flow of hydraulic oil is released during return movements of the coupling part. As already mentioned, the displaceably guided coupling sleeve may be designed as an electrical connection contact and the opposite part may be designed as a mating contact.

An exemplary embodiment of the subject matter of the invention is shown in the drawing.

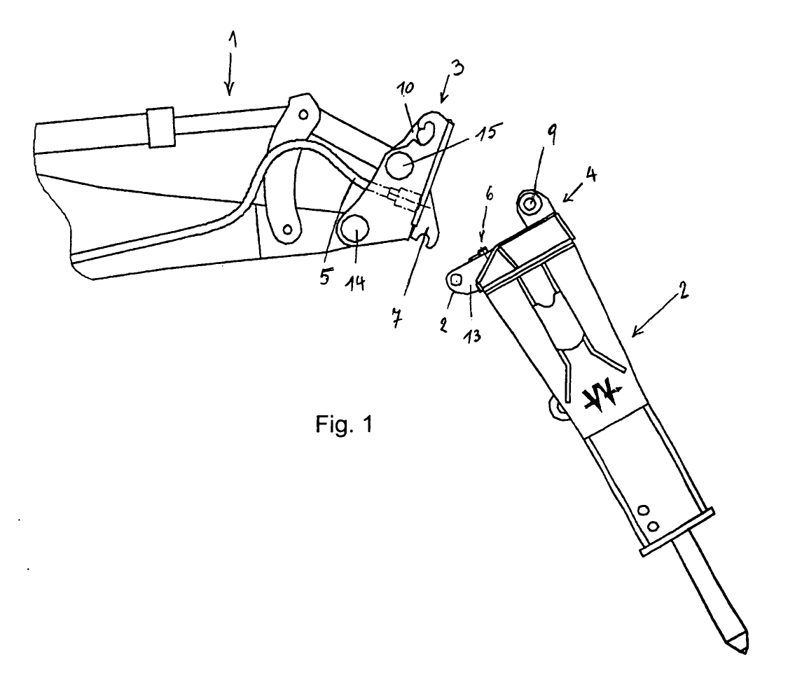

FIG. 1 shows a general side view of a tool which can be hydraulically pressurized, and the end of an excavator boom, this end having the tool carrier.

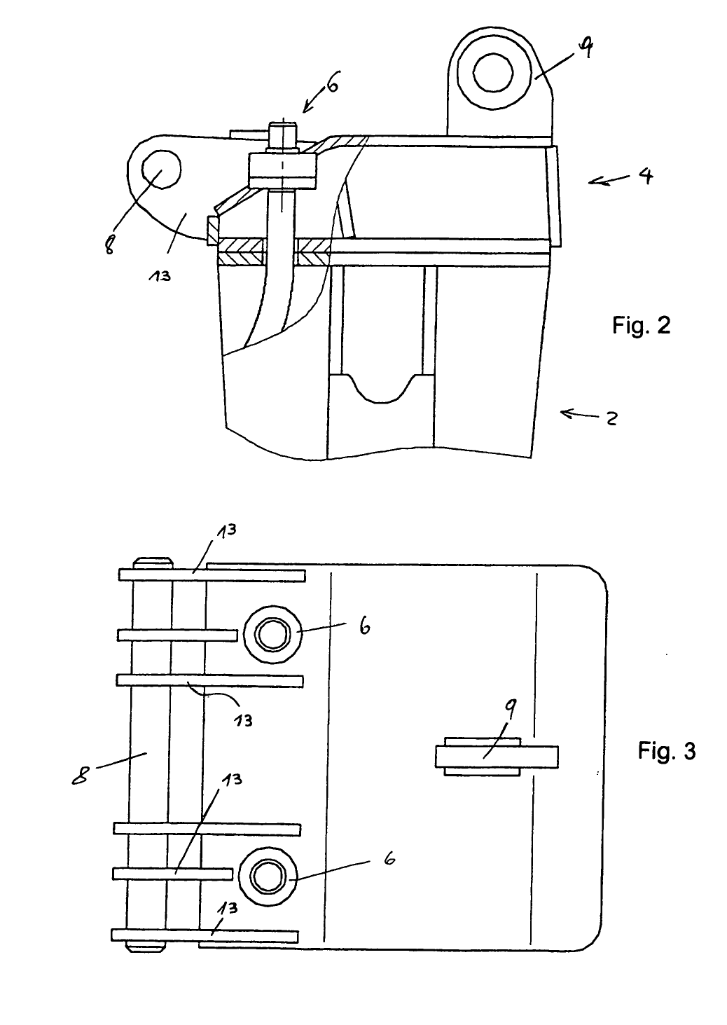

FIG. 2 is a side view of the connecting piece of the tool.

FIG. 3 is a plan view of this part.

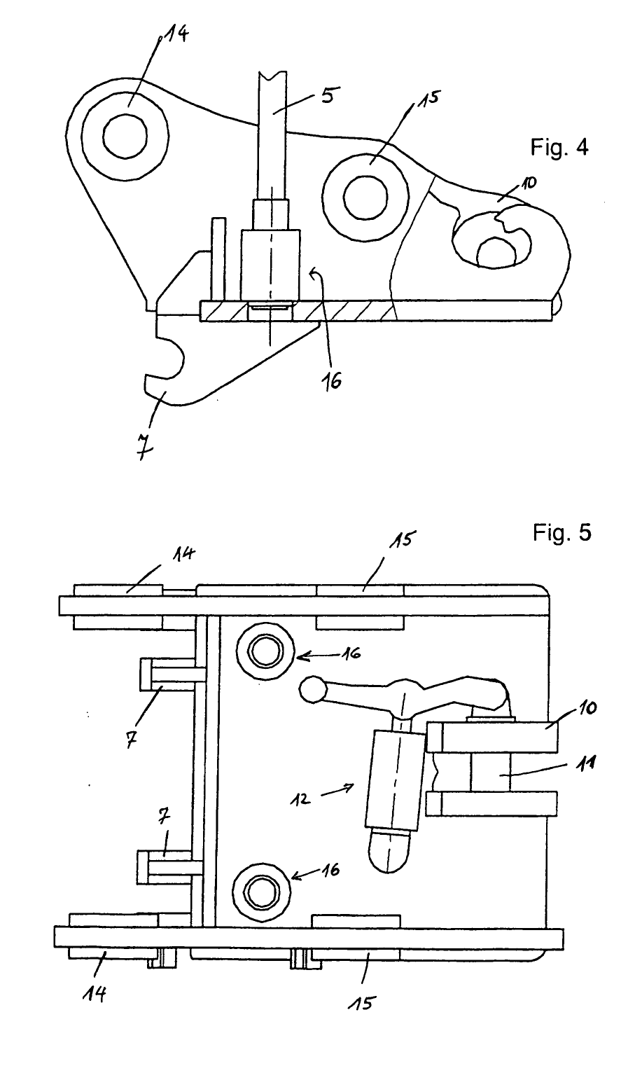

FIG. 4 reproduces the tool carrier in side view, partly in section.

FIG. 5 is a plan view of this tool carrier.

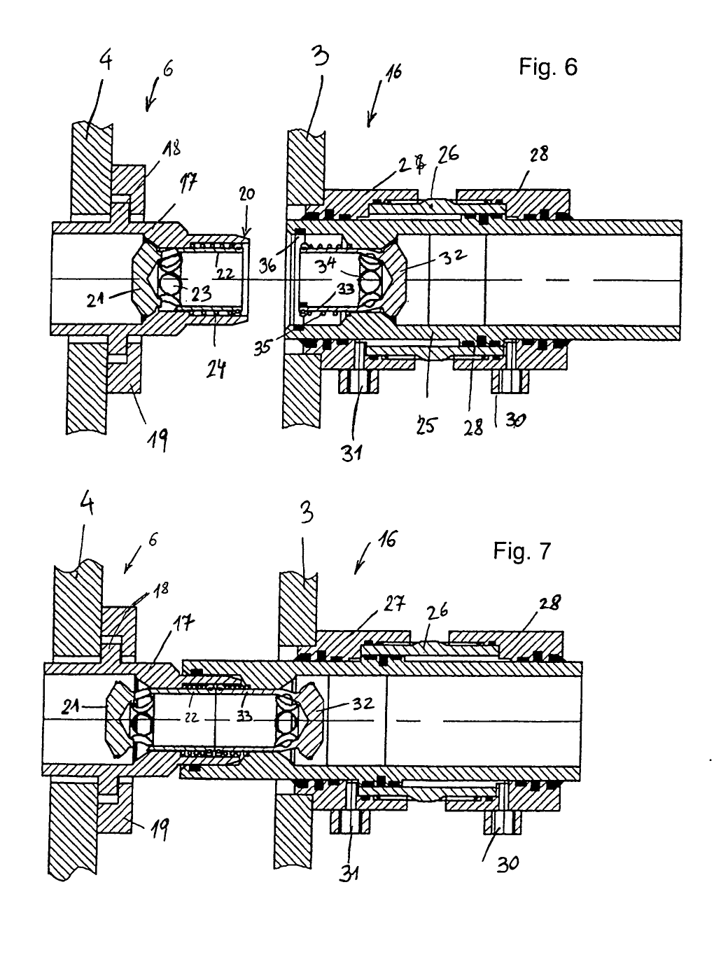

FIG. 6 reproduces in section the hydraulic coupling between the pressure line and the tool, with coupling parts separated from one another.

FIG. 7 shows the parts reproduced in FIG. 6 in the coupled state.

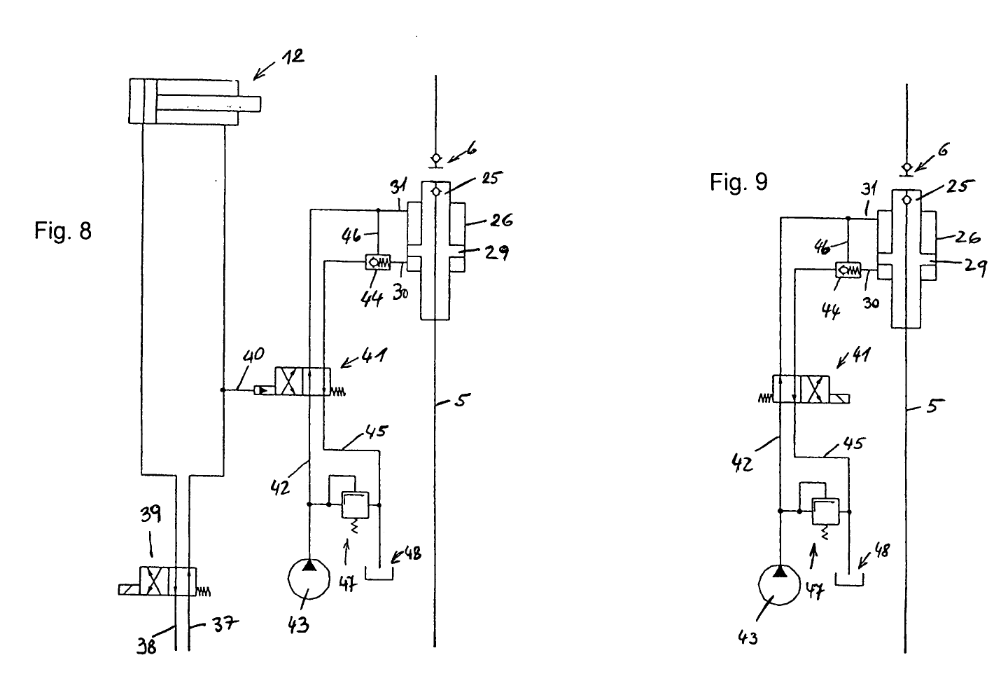

FIGS. 8 to 11 illustrate various embodiments of the hydraulic circuit for the actuation of the coupling for the energy lines.

Designated by 1 is the end of an excavator boom, to which a hydraulically operated tool 2, in the present case a demolition or cutter pick, is connected via a tool carrier 3 and a coupling plate 4. The hydraulic feed line at the tool carrier 3 is designated by 5 and the mating coupling part at the tool is designated by 6.

To connect the tool carrier to the tool, a hook 7 is provided on the tool-carrier coupling part 3 and can be hooked in place on a rod 8 which is attached to the tool coupling plate 4 via a support 13. At the region remote from the rod 8, the tool coupling plate 4 has a lug 9 which projects in the direction of the tool-carrier coupling plate 3 and which can be pushed in between two guide lugs 10 and is oriented in such a way that openings of the lugs 9, 10 are in alignment in the coupling position. As soon as the alignment is achieved, a coupling pin 11 is pushed through the holes of the lugs 9, 10 by means of a locking cylinder 12, whereby the tool is secured to the tool carrier in a locked manner. In this case, the tool-carrier coupling part 3 is connected to the free end of the excavator boom 1 via connections 14, 15.

In this connected state, the coupling part 16 connected to the hydraulic line 5 lies coaxially opposite the mating coupling part 6 on the tool. This position is reproduced in detail in FIG. 6.

In the present case, the mating coupling part 6 is formed by a rigid tubular part 17, which bears via a flange 18 against the tool coupling plate 4 and is secured to the tool coupling plate 4 by means of a ring 19. As can be seen from FIG. 6, both the tubular part 17 and the flange 18 lie in the tool coupling plate 4 or in the ring 19, the tubular part 17 or the flange 18 being fixed in the axial direction by means of the ring 19. The result of this is that the tubular part 17 is laterally displaceable in the coupling plate 4 to a limited extent in the radial direction but is fixed in the axial direction and thus can certainly give way laterally, but not in the axial direction, when the coupling is actuated. In this case, the tubular part 17 is conically beveled at 20 at its free end pointing outward.

Provided in the interior of the tubular part 17 is a valve plug 21, which is directed into the tubular part 17 via a collar 22. Through-openings 23 are provided in the valve plug for the passage of the pressure medium. In order to ensure that the valve 21 reliably closes, a helical spring 24 is provided. In this case, the valve plug 21 has a conical valve sealing surface, which can be brought to bear against a mating surface in the tubular part 17. Such self-closing valves in line coupling parts are general prior art.

Provided at the coupling part 16 connected to the line 5 is a coupling sleeve 25 which is displaceably guided in the axial direction in a cylinder 26. In this case, the cylinder 26 is firmly connected to the tool-carrier coupling part 3 via fastening rings 27, 28.

The coupling sleeve 25 is guided in the cylinder via an encircling guide ring 29 which is sealed off from the cylinder wall. The ring 29 thus subdivides the cylinder interior space into two annular chambers, a respective pressure connection 30, 31 being provided at each end of the chamber. In a similar manner to the end of the tube 17, a valve plug 32 is likewise provided in the interior of the guide sleeve 25, this valve plug 32 being guided in the valve sleeve via a collar 33 and having through-openings 34. This plug 32 is also loaded via a spring 35 in the closing direction of the pressure line. The pressure line 5 is tightly connected to the guide sleeve 25 on the side remote from the valve plug.

In the present exemplary embodiment, by introducing pressure medium via the pressure connection 30, the guide sleeve 25 is displaced from the position reproduced in FIG. 6 toward the tubular part 17 and is pushed over the conical end 20 onto the cylindrical region of the tube 17, a seal 36 inside the coupling sleeve effecting a tight closure relative to the outer wall of the cylindrical end region of the tube 17. On account of the conical design of the end of the tube 17 and of the slightly funnel-shaped beveling of the sleeve 25, mutual centering of the two lines to be connected is effected, it being possible, as already mentioned, for the tubular part 17 to give way laterally to such an extent that a coaxial position of the line parts to be connected is achieved here.

As can be seen from FIG. 7, the coupling sleeve 25 is pushed completely onto the cylindrical part of the tube 17, the two guide collars 22, 33 of the valve plugs 21 and 32, in this position, bearing against one another with their side remote from the valve plate, and the valve plugs 21 and 32, in this position, lifting from the corresponding seats in the tube 17 and in the sleeve 25, respectively, for a free passage of medium.

It is shown in FIGS. 6 and 7 that the coupling sleeve 25 is pushed on on the outside over the tubular part 17. In the same manner, the coupling sleeve 25 could of course be designed conversely in such a way that it can be inserted into the tube 17 in a sealing manner at the inner wall. It is merely a question of dimensioning the outer part.

To advance the coupling sleeve, pressure medium is introduced via the connection 30 into the interior of the cylinder 26, into the chamber of the cylinder 26 lying at the back in the direction of advance, as a result of which the ring 29 and thus the coupling sleeve 25 are advanced in the direction of the mating coupling part. If the coupling is to be released, pressure medium is introduced via the part 31, as a result of which the corresponding return movement of the coupling sleeve 25 is effected. It can be seen from the drawings that the cylindrical sealing region of the tube 17 and thus also the path on which the sealing ring 36 bears against the tube 17 is longer than the stroke of the two valve plugs 21, 32, the result of which is that, during the coupling, the valve plugs 21 and 32 are lifted from the corresponding valve seats only as soon as a seal is achieved between the coupling sleeve 25 and the tube 17 via the sealing ring 36. During the release, too, sealing is first effected via the valve plugs 21, 32, and only then does the coupling sleeve 25 slide down from the coupling tube of the mating coupling part 6.

Various circuit variants for pressurizing the cylinder 26 for the actuation of the coupling sleeve 25 are reproduced in FIGS. 8 to 11. FIG. 8 shows combined pressurizing with the locking cylinder 12, pressure medium being fed to the locking cylinder 12 via the line 37 and being discharged from the latter via the line 38. 39 is the corresponding control valve for locking or unlocking the locking cylinder. Branching off from the pressure feed line for the locking position of the locking cylinder 12 is a branch line 40, by means of which a control valve 41 is activated for the actuation of the coupling sleeve 25 in the cylinder 26. The control valve 41 is provided with a pressure feed line 42 and a return line 45, a pump 43 being connected to the control line 42 for the pressure generation. Fitted in the return line is a pilot-controlled check valve 44, which can be opened via the line 46. Provided at 47 is a bypass circuit for avoiding excess pressures in the line 42. 48 is the return tank from the line 45.

If the locking cylinder is actuated via the line 37 for the purpose of pushing in the coupling pin 11, the pressure increases in the line after completion of the advance movement, as a result of which the control valve 41, via the line 40, then shifts against a spring force from the position reproduced in FIG. 8 into the second position, with which pressure from the line 42 is introduced via the pilot-controlled check valve 44 and the pressure connection 30 into the cylinder space lying at the back in the direction of advance of the coupling sleeve 25, as a result of which the coupling sleeve 25 is advanced in the direction of the mating coupling part 6. In this position, with the position of the valve 41, the coupling sleeve 25 automatically remains fixed in the coupled position on account of the pressure behind the piston 29. To retract the coupling sleeve 25, first the control valve 39 for the locking cylinder is shifted into the second position, as a result of which pressure can flow off from the line 40 via the line 38, so that the control valve 41 passes into the position reproduced in FIG. 8. Thus the cylinder chamber lying at the front in the direction of advance is pressurized via the connection 31, the pilot-controlled check valve 44 being opened via the line 46, and thus, for the purposes of a return movement of the coupling sleeve 25, the pressure medium can pass into the collecting space 48 via the line 30, the control valve 41 and the line 45.

The control circuit according to FIG. 9 is constructed in a similar manner to FIG. 8, with the difference that, instead of the pressurizing of the control valve 41 via the pressure line 40, an electromagnet is provided. The pressure characteristic within the control circuit for the cylinder 26 is effected in the same manner as according to FIG. 8, with the exception that the actuation of the control valve 41 can be controlled independently of the actuation of the locking cylinder.

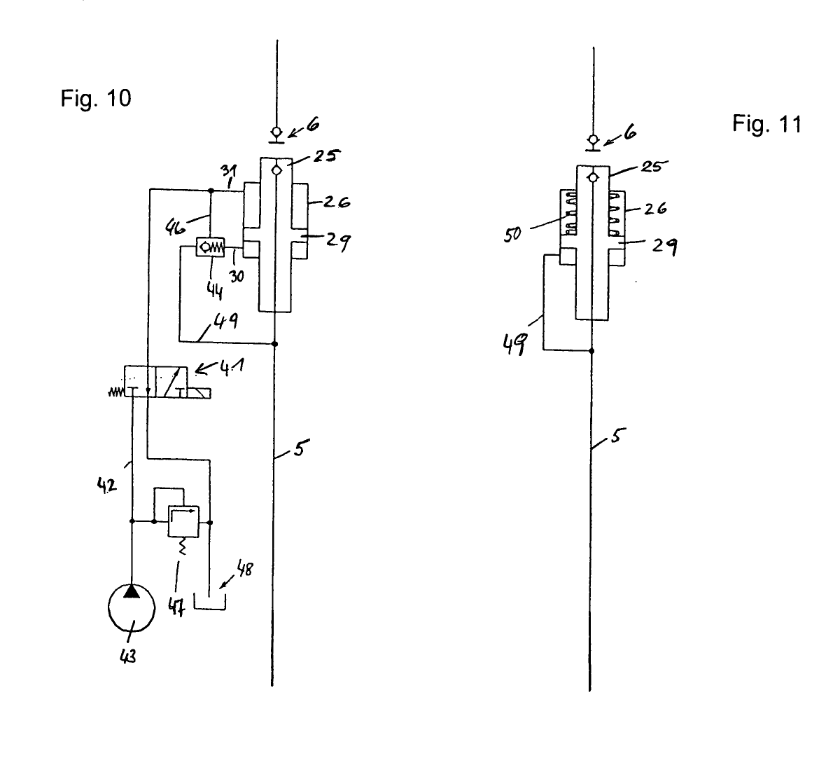

In the exemplary embodiment according to FIG. 10, for applying pressure to the piston 29 of the coupling sleeve 25, the pressure provided via the general hydraulic pressure line for actuating the hydraulic tool is fed directly to the pilot-controlled check valve 44 via a branch line 49, the pressure applied by the pump 43 via the line 42 merely serving to move the coupling sleeve 25 back via the connection 31 by pressurizing the cylinder 26. The pilot-controlled check valve 44 is opened in the same way as according to FIG. 8 via the pressure control line 46. In the same way as in the embodiment according to FIG. 9, the control valve 41 according to FIG. 10 can be shifted via an electrically operated valve or via another actuating means, e.g. possibly also manually.

If pressure is applied to the pressure line 5 in the embodiment according to FIG. 10, and this pressure is then also used in the same way for the actuation of the tool, first of all, in view of the fact that the end of the coupling sleeve 25 is closed off by the valve plug 32, pressure builds up in the line 49, and this pressure, by means of the pilot-controlled check valve 44 and the pressure connection 30, is applied to the cylinder 26 in space lying behind the piston 29, as a result of which the coupling sleeve 25 is brought into engagement with the mating coupling part 6. The coupling sleeve is then again held in the coupled state by the pilot-controlled check valve 44, still in the closed state, preventing the pressure medium from flowing off from the cylinder space via the pressure connection 30. To move back the coupling sleeve 25, the valve 41 is shifted from the first position shown in FIG. 10 into the second position, whereby the pressure medium brought to the control valve 41 via the line 42 passes into the line 31 and thus opens the valve 44 via the line 46. The pressure introduced into the cylinder space in front of the piston 29 moves the coupling sleeve 25 back, the fluid forced out of the chamber behind the piston 29 being fed back into the pressure line 5 via the pilot-controlled check valve 44 and the line 49.

The simple coupling circuit reproduced in FIG. 11 is provided merely to advance the coupling sleeve 25 via the pressure applied via the pressure line 5. To this end, a compression spring 50 is provided in the interior of the cylinder 26 and acts on the piston 29 for the purpose of retracting the coupling sleeve 25. If pressure is now introduced into the coupling sleeve 25 via the line 5, pressure builds up in the line 49 and thus in the cylinder space lying behind the piston 29, to be precise until the valve plug 32 bears tightly against the end of the coupling sleeve 25. After the coupling sleeve 25 is coupled to the mating coupling part 6, the piston 29, on account of the pressurizing 5 via the line 49, remains in its front position loaded by the spring 50, whereby the tight connection between the coupling sleeve 25 and the mating coupling part 6 is maintained. As soon as pressure is let off from the line 5, the compression spring 50 can retract the coupling sleeve 25 from the engagement with the mating coupling part 6, in the course of which the pressure fluid located in the cylinder space can flow off via the line 49 and the line 5.

As mentioned, an electrical feed line may also be provided instead of a pressure line 5, although only the controls according to FIGS. 8 and 9 may then be used.

1-7. (canceled)

8. An assembly for connecting an energy line to a tool to be supplied with energy while the tool is fixedly mounted and locked to a tool carrier, the assembly comprising:
two coupling parts respectively disposed on the tool and on the tool carrier, said coupling parts being disposed coaxially opposite one another when the tool is fixedly mounted and locked to the tool carrier, and one of said coupling parts engaging in the opposite mating coupling part in the coupled state; and
one of said coupling parts including a coupling sleeve configured to be tightly guided in a displaceable manner in an axial direction of said one coupling part and to be sealingly pushed into or onto the respectively opposite said coupling part.

9. The assembly according to claim 8, wherein said coupling sleeve forms a part of said coupling part on the tool carrier.

10. The assembly according to claim 8, wherein said coupling parts are configured to connect pressure lines to the tool.

11. The assembly according to claim 10, wherein the pressure lines are hydraulic lines.

12. The assembly according to claim 8, wherein said coupling parts are configured for connecting pressure-actuated tools to pressure supply lines.

13. The assembly according to claim 8, wherein said displaceably guided coupling sleeve includes a guide formed as a hydraulic cylinder, with a piston formed by a ring disposed on an outer lateral surface of said coupling sleeve.

14. The assembly according to claim 13, wherein a stroke of said hydraulic cylinder is greater than a distance between said two coupling parts.

15. The assembly according to claim 8, wherein at least one of said coupling parts is mounted on a carrier in a floating manner and to be movable to a limited extent in an axial direction.

16. The assembly according to claim 8, wherein an end of said coupling sleeve configured to be inserted into the mating coupling part tapers conically toward a free edge.

17. The assembly according to claims 8, which comprises a pilot-controlled check valve in a hydraulic circuit pressurizing said coupling sleeve.

18. The assembly according to claims 13, which comprises a pilot-controlled check valve in a hydraulic line leading in on a rear side of said piston.

19. The assembly according to claim 8, wherein said displaceably guided coupling sleeve forms an electrical contact and a respectively opposite part is formed as a mating contact.
